(19) United States
(12) Patent Application Publication
(10) Pub. No.: US 2011/0191721 A1
(43) Pub. Date: Aug. 4, 2011

(54) METHOD AND APPARATUS FOR DISPLAYING ADDITIONAL INFORMATION OF CONTENT

(75) Inventors: Kwang-pyo CHOI, Anyang-si (KR); Han-sang KIM, Suwon-si (KR)

(73) Assignee: SAMSUNG ELECTRONICS CO., LTD., Suwon-si (KR)

(21) Appl. No.: 12/981,223

(22) Filed: Dec. 29, 2010

(30) Foreign Application Priority Data
Feb. 4, 2010 (KR) 10-2010-0010478

(51) Int. Cl. G06F 3/048

(52) U.S. Cl. 715/838

(57) ABSTRACT

A method and apparatus that display information about content as a thumbnail. The thumbnail may be an image that represents the content, and the thumbnail may be generated to include first and second portions based on information about the content. The information on the content may indicate a point of progress within the content, and the first and second portions may represent time segments of the content, occurring before and after the point of progress, and the first and second portions may be distinguishably displayed from each other to convey the point of progress to a user.

### CROSS-REFERENCE TO RELATED PATENT APPLICATION

This application claims priority from Korean Patent Application No. 10-2010-0010478, filed on Feb. 4, 2010, in the Korean Intellectual Property Office, the disclosure of which is incorporated herein by reference in its entirety.

### BACKGROUND

1. Field

The present disclosure relates to a method and apparatus for displaying additional information of content, and more particularly, to a method and apparatus for displaying additional information of content by displaying additional information related to content via a thumbnail image, which represents the content.

2. Description of the Related Art

Currently, various devices support playback of motion picture contents and provide information related to contents by displaying titles of contents in text form or by displaying thumbnail images. Thumbnail images help a user to select content by decoding motion picture content and displaying portions of motion pictures. FIG. 1 shows a conventional method of displaying thumbnails, in which a list of contents, which includes thumbnail images 110, filenames 120, file sizes 121, and overall playback times 122, is displayed. Such a method of displaying thumbnails may only provide information regarding features of content itself. FIG. 2 shows a conventional method of displaying remaining power of a battery. Such a method may only provide information regarding battery power, and possible playback time of content with the currently remaining battery power may not be determined.

### SUMMARY

Exemplary embodiments include a method and apparatus for displaying additional information of content by displaying additional information related to content via a thumbnail image, which represents the content.

According to an exemplary embodiment, there is provided a method of displaying information about content, the method including obtaining a thumbnail image and additional information related to the content; modifying the thumbnail image based on the additional information; and displaying the modified thumbnail image.

The obtaining may include determining a position of the content at which playback of the content has stopped with respect to an entire playback length of time of the content, based on a playback history of the content, and the modifying may include modifying a first portion of the thumbnail image that corresponds to a first amount of time of the content that precedes the position to be distinguishable from a second portion of the thumbnail image that corresponds to a second amount of time of the content that follows the position.

The modifying the first portion to be distinguishable from the second portion may include modifying a color of the first portion of the thumbnail image to be a grayscale color.

The obtaining of additional information may include determining a remaining power of a playback device that outputs the content and estimating a possible playback time of the content based on the remaining power, and the modifying may include modifying a first portion of the thumbnail image that corresponds to a first amount of time of the content that precedes the possible playback time to be distinguishable from a second portion of the thumbnail image that corresponds to a second amount of time of the content that follows the possible playback time.

The obtaining may include obtaining information regarding an estimated playback time of the content, and the modifying may include mapping the entire thumbnail image to an overall playback time of the content and modifying a first portion of the thumbnail image corresponding to a segment of the content which is estimated to be played back to be distinguishable from a second portion of the thumbnail image corresponding to a segment of the content which is estimated to not be played back.

The modifying may include changing a color of a portion of the thumbnail image based on the additional information.

The method may further include obtaining a second thumbnail image and second additional information related to second content and modifying the second thumbnail image based on the second additional information, and the displaying may include displaying the modified thumbnail image and the modified second thumbnail image as a list.

According to another exemplary embodiment, there is provided an apparatus for displaying information about content, the apparatus may include a storage unit that stores information about the content; an output unit; and a control unit that obtains a thumbnail image and additional information related to the content, modifies the thumbnail image based on the additional information, and displaying the modified thumbnail image via the output unit.

### BRIEF DESCRIPTION OF THE DRAWINGS

The above and other advantages will become more apparent by describing in detail exemplary embodiments thereof with reference to the attached drawings in which:

FIG. 1 shows a conventional method of displaying thumbnails;

FIG. 2 shows a conventional method of displaying remaining power of a battery;

FIG. 3 is a schematic view of an apparatus for displaying additional information, according to an exemplary embodiment;

FIG. 4 is a flowchart of a method of displaying additional information according to an exemplary embodiment;

FIG. 5 is a flowchart of a method of displaying additional information, according to another exemplary embodiment;

FIGS. 6A, 6B, and 6C show examples of thumbnail images according to the exemplary embodiment shown in FIG. 5;

FIG. 7 is a flowchart of a method of displaying additional information according to another exemplary embodiment; and

FIG. 8 shows an example of thumbnail images according to the exemplary embodiment shown in FIG. 7.

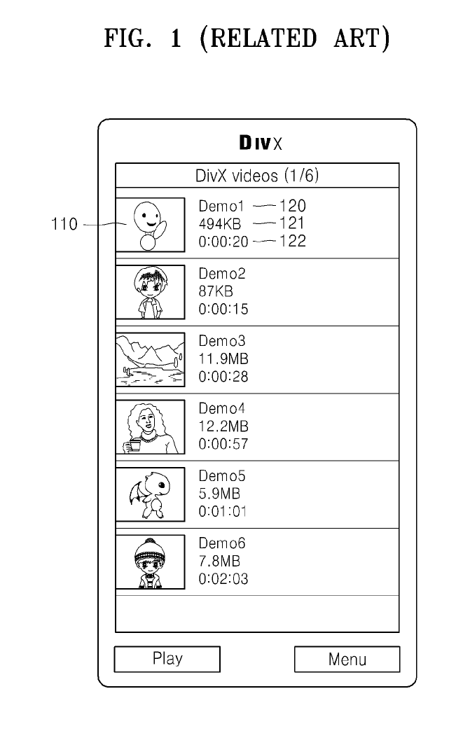

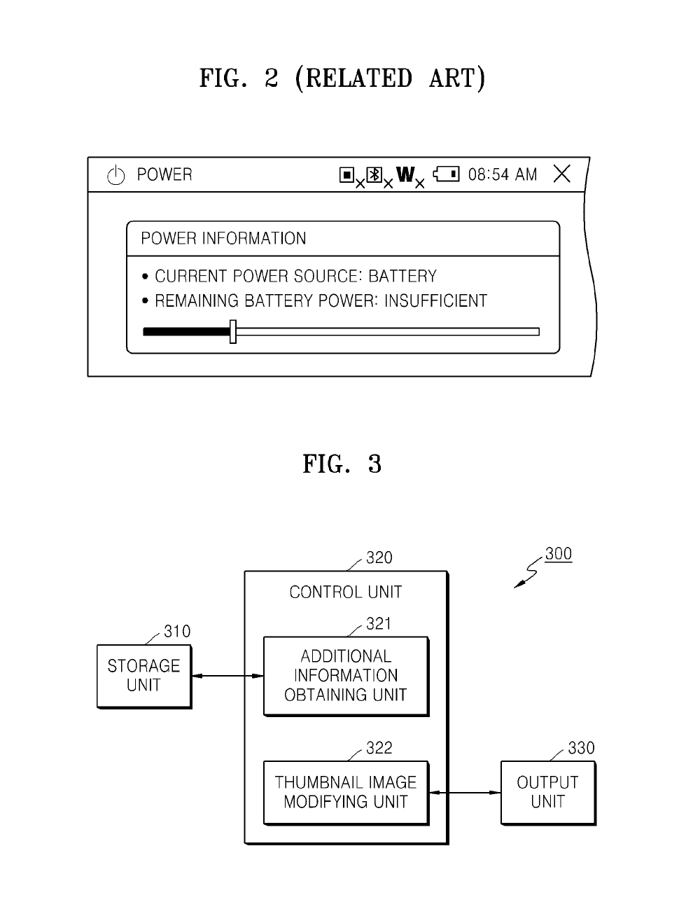

### DETAILED DESCRIPTION OF EXEMPLARY EMBODIMENTS

FIG. 3 is a schematic view of an apparatus 300 for displaying additional information, according to an exemplary embodiment.

Referring to FIG. 3, the apparatus 300 includes a storage unit 310 that stores content-related information, an output unit 330, and a control unit 320 that processes content-related information read from the storage unit 310 and that displays a result of processing via the output unit 330. The control unit 320 includes an additional information obtaining unit 321 that obtains a thumbnail image and additional information related to the content and a thumbnail image modifying unit 322 that modifies the thumbnail image based on the obtained additional information. The control unit 320 displays the modified thumbnail image via the output unit 330. The control unit 320 may be a microprocessor. The storage unit 310 may be a memory such as, for example, a read only memory (ROM), random access memory (RAM), flash memory, or the like.

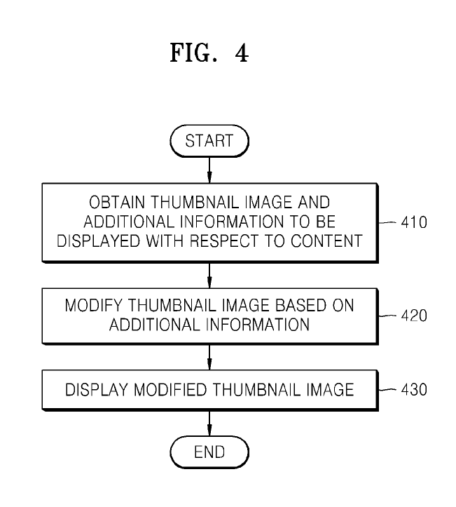

Detailed descriptions of functions, operations, and various embodiments of the control unit 320 will be given below with reference to FIGS. 4 through 8.

FIG. 4 is a flowchart of a method of displaying additional information, according to an exemplary embodiment.

Referring to FIGS. 3 and 4, the additional information obtaining unit 321 obtains a thumbnail image and additional information with respect to content by using information stored in the storage unit 310 (operation 410). A thumbnail image is a small-size image representing content. The thumbnail image may be created by using a first image or a first key frame that is output by decoding the content or by using a representative image provided by a content creator. However, the present exemplary embodiment is not limited thereto. Additional information is information related to content and represented by using the thumbnail image. For example, to obtain additional information, the additional information obtaining unit 321 estimates playback time of content to predict a specific portion of the content to be played back by a user and a specific portion of the content not to be played back by the user. Information regarding a point of the content up to which the user watched the content or remaining power of a device may be used for the estimation of playback time.

The thumbnail image modifying unit 322 modifies a thumbnail image based on obtained additional information (operation 420). Modification of a thumbnail image may entail changing the color of a particular region in the thumbnail image, grayscaling the thumbnail image, or changing the size or the shape of the thumbnail image. However, the present exemplary embodiment is not limited thereto, and any of various methods for displaying additional information may be employed. If additional information to be displayed includes information regarding estimated playback time of content, the entire thumbnail image is mapped to the overall playback time of the content, and a portion of the thumbnail image corresponding to a segment of the content, which is estimated to be played back, and another portion of the thumbnail image corresponding to another segment of the content, which is estimated not to be played back, are indicated differently.

A modified thumbnail image is displayed by the output unit 330 (operation 430). At this point, information for identifying corresponding content, such as content filenames or content titles, may be displayed. Furthermore, text indicating additional information displayed on the thumbnail image and the size of content may also be displayed. Displayed information may be a list of contents, and each of the items in the list of contents may include information that identifies corresponding content and a modified thumbnail image obtained in operations 410 and 420.

Since additional information is displayed, not as text, but as modifications of a thumbnail image, a user may intuitively recognize the additional information, and the recognized additional information helps the user to select content.

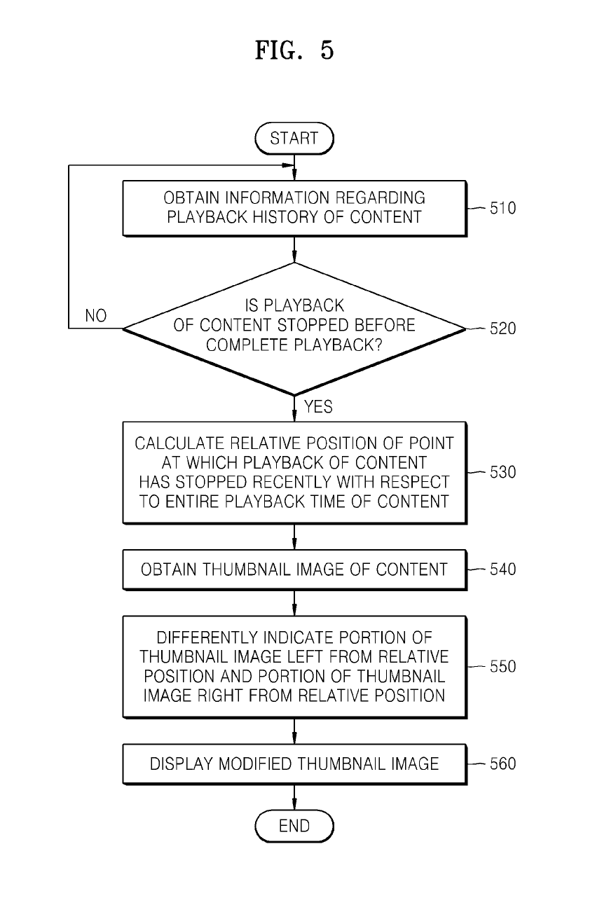

FIG. 5 is a flowchart of a method of displaying additional information according to another exemplary embodiment, in which a point of content, up to which a user has recently watched the content, is indicated.

Referring to FIG. 5, playback history information of content is obtained (operation 510). The playback history information includes a point at which playback of content has been stopped. Information regarding points at which playback of each of contents have been stopped may be obtained from a playback log file or a database, in which the history of content playback is stored. However, the present exemplary embodiment is not limited thereto, and various modifications may be made herein. In operation 520, it is determined whether a point at which playback of content has been stopped is located between a starting point and an end point of the content. If the point at which playback of the content has been stopped is the starting point of playback of the content, a user has not watched the corresponding content, and thus it is not necessary to modify a corresponding thumbnail image. If the point at which playback of the content has been stopped is the end point of playback of the content, a user has played back the entire corresponding content, and thus it is not necessary to modify a corresponding thumbnail image. If the point at which playback of the content has been stopped is between the starting point and the end point of the content, it is necessary to modify a corresponding thumbnail image to indicate the point at which playback of the content has been stopped.

If it is determined that playback of content has been recently stopped before the content is completely played back, information regarding the entire playback time of the content is obtained. The information may be obtained from metadata of the content or from a database in which information regarding the content is stored. However, the present exemplary embodiment is not limited thereto, and various modifications may be made herein. A relative position of a final point at which playback of the content has been stopped with respect to the entire playback time of the content is calculated (operation 530). For example, if playback of content with an entire playback time of 60 minutes has been stopped after 12 minutes, the relative position of the final point at which playback of the content has been stopped with respect to the entire playback time of the content is 0.2.

Relative Position=Point At Which Playback Has Been Stopped/Entire Playback Time [Equation 1]

A thumbnail image corresponding to content is obtained (operation 540). The thumbnail image corresponding to content may be generated by using a first key frame of the content. Alternatively, a key frame corresponding to the relative position calculated in operation 530 may be extracted from the content via a decoder and used as a thumbnail image. The obtained thumbnail image is modified based on the relative position calculated in operation 530, where a left portion and a right portion of the thumbnail image with respect to the relative position are indicated differently (operation 550). For example, since the left portion of the thumbnail image from the relative position is the portion of content a user has already watched, the left portion is modified to be a grayscale portion. On the contrary, since the right portion of the thumbnail image from the relative position is the portion of content expected to be watched by the user, the original thumbnail image is used in the right portion. According to another exemplary embodiment, the left portion of the thumbnail image may be modified to be a different color. The modified thumbnail image is displayed via the output unit 330 (operation 560).

In the case of displaying a list of contents for content selection, operations 510 through 560 are repeated with respect to each of the contents, and the titles of content files are displayed with modified thumbnail images.

Furthermore, although a corresponding thumbnail image is not modified in the case where a user has completely watched a corresponding content in the embodiment shown in FIG. 5, the entire thumbnail image of the corresponding content may also be modified to be a grayscale portion so as to distinguish the corresponding content from contents the user has not yet watched and to indicate that the user has already watched the corresponding content completely.

A user may intuitively learn about contents he or she has previously watched through information displayed on thumbnail images of contents, where the information is in regard to the playback history of the contents.

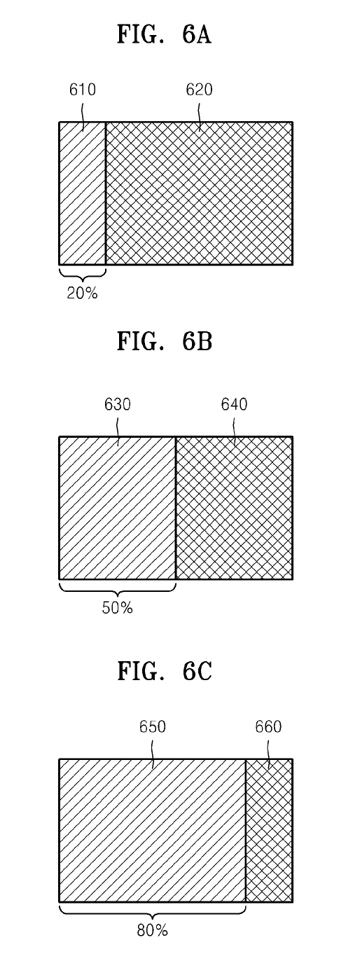

FIGS. 6A through 6C show examples of thumbnail images according to the exemplary embodiment shown in FIG. 5.

Referring to FIG. 6A, in the case where playback of content with an entire playback time of 100 minutes has been stopped after 20 minutes, the relative position calculated based on Equation 1 is 0.2. Therefore, a portion 610 on the left of the relative position, which corresponds to the left 20% of a thumbnail image, is modified to be a grayscale portion, and a remaining portion 620 of the thumbnail image is unchanged.

Referring to FIG. 6B, in the case where playback of content with an entire playback time of 100 minutes has been stopped after 50 minutes, the relative position calculated based on Equation 1 is 0.5. Therefore, a portion 630 on the left of the relative position, which corresponds to the left half of a thumbnail image, is modified to be a grayscale portion, and a remaining portion 640 of the thumbnail image is unchanged.

Referring to FIG. 6C, in the case where playback of content with an entire playback time of 100 minutes has been stopped after 80 minutes, the relative position calculated based on Equation 1 is 0.8. Therefore, a portion 650 on the left of the relative position, which corresponds to the left 80% of a thumbnail image, is modified to be a grayscale portion, and a remaining portion 660 of the thumbnail image is unchanged.

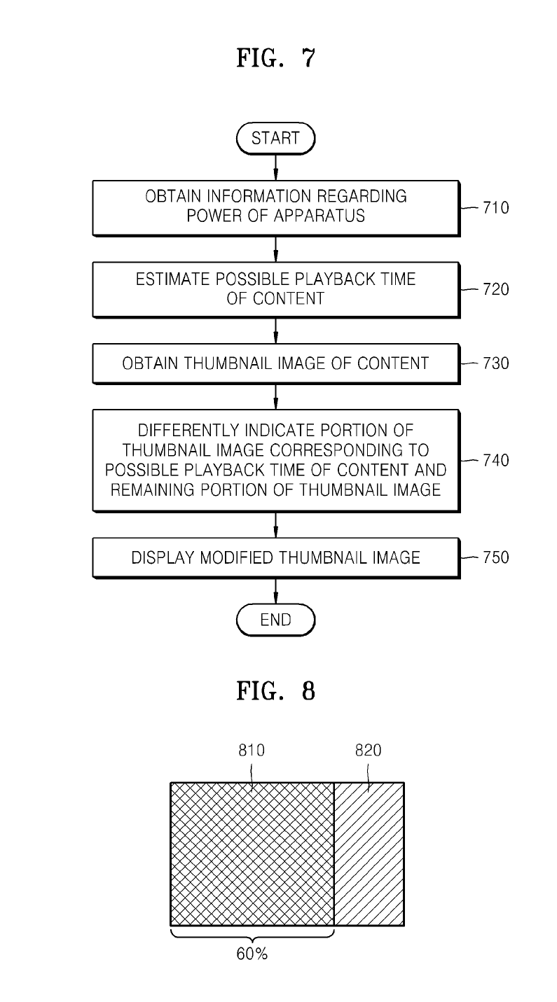

FIG. 7 is a flowchart of a method of displaying additional information according to another exemplary embodiment, in which a possible playback time of content with currently remaining power may be displayed.

Referring to FIG. 7, information regarding power of the apparatus 300 is obtained (operation 710). The information regarding power of the apparatus 300 includes information regarding currently remaining power. The playback time of content, which is possible with the currently remaining power, is estimated (operation 720). The estimation of the possible playback time requires information regarding the bit rate of the content, the duration of the content, and the length and the width of images, which is obtained from among internal information related to the corresponding content. A thumbnail image corresponding to the content is obtained (operation 730). The thumbnail image is modified so that a portion of the content that may be played back and a remaining portion of the content are indicated differently (operation 740), and the thumbnail image is displayed (operation 750).

If the entire playback time of content is referred to as T and the actual possible playback time of the content is referred to as t, a thumbnail image may be modified as follows:

if x≦(t×W)/T,I′(x,y)=I(x,y)

else I′(x,y)=G(I(x,y)) [Equation 2]

Here, W indicates the width of a thumbnail image, H indicates the height of the thumbnail image, I(x, y) indicates a value of a pixel of the thumbnail image at the coordinate (x, y) (0≦x<W, 0≦y<H), the G( ) calculation refers to a calculation for deleting color information of the pixel and modifying the pixel to be grayscale, and I′(x, y) indicates a new value of the pixel of the thumbnail image generated as a result of the modification.

If a plurality of contents are to be indicated with thumbnail images, the method is repeated to modify and display thumbnail images with respect to each of the contents.

In the case where the battery duration is limited as in mobile apparatuses, the possible playback time of particular content is indicated by comparing the remaining battery duration and the amount of power required for content playback, and thus a user may select content in consideration of the remaining power.

FIG. 8 shows an example of thumbnail images according to the exemplary embodiment shown in FIG. 7.

Referring to FIG. 8, it is estimated that only 60% of content may be played back with the currently remaining power, and thus a portion 810 of the thumbnail image corresponding to the possible playback time is unchanged, whereas a remaining portion 820 of the thumbnail image is modified to be grayscale.

The exemplary embodiments can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

While the present disclosure has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of displaying information about content, the method comprising:
obtaining a thumbnail image and additional information related to the content;
modifying the thumbnail image based on the additional information; and
displaying the modified thumbnail image.

2. The method of claim 1, wherein the obtaining comprises determining a position of the content at which playback of the content has stopped with respect to an entire playback length of time of the content, based on a playback history of the content, and
wherein the modifying comprises modifying a first portion of the thumbnail image that corresponds to a first amount of time of the content that precedes the position to be distinguishable from a second portion of the thumbnail image that corresponds to a second amount of time of the content that follows the position.

3. The method of claim 2, wherein the modifying the first portion to be distinguishable from the second portion comprises modifying a color of the first portion of the thumbnail image to be a grayscale color.

4. The method of claim 1, wherein the obtaining of additional information comprises determining a remaining power of a playback device that outputs the content and estimating a possible playback time of the content based on the remaining power, and
wherein the modifying comprises modifying a first portion of the thumbnail image that corresponds to a first amount of time of the content that precedes the possible playback time to be distinguishable from a second portion of the thumbnail image that corresponds to a second amount of time of the content that follows the possible playback time.

5. The method of claim 4, wherein the modifying the first potion to be distinguishable from the second portion comprises modifying a color of the second portion of the thumbnail image to be a grayscale color.

6. The method of claim 1, wherein the obtaining comprises obtaining information regarding an estimated playback time of the content, and
wherein the modifying comprises mapping the entire thumbnail image to an overall playback time of the content and modifying a first portion of the thumbnail image corresponding to a segment of the content which is estimated to be played back to be distinguishable from a second portion of the thumbnail image corresponding to a segment of the content which is estimated to not be played back.

7. The method of claim 1, wherein the modifying comprises changing a color of a portion of the thumbnail image based on the additional information.

8. The method of claim 1, further comprising:
obtaining a second thumbnail image and second additional information related to second content; and
modifying the second thumbnail image based on the second additional information,
wherein the displaying comprises displaying the modified thumbnail image and the modified second thumbnail image as a list.

9. A computer readable recording medium having recorded thereon a program that causes a computer to execute a method of displaying information about content, the method comprising:
obtaining a thumbnail image and additional information related to the content;
modifying the thumbnail image based on the additional information; and
displaying the modified thumbnail image.

10. An apparatus for displaying information about content, the apparatus comprising:
a storage unit that stores information about the content;
an output unit; and
a control unit that obtains a thumbnail image and additional information related to the content, modifies the thumbnail image based on the additional information, and displaying the modified thumbnail image via the output unit.

11. The apparatus of claim 10, wherein the control unit determines a position of the convent at which playback of the content has stopped with respect to an entire playback length of time of the content, based on a playback history of the content and modifies a first portion of the thumbnail image that corresponds to a first amount of time of the content that precedes the position to be distinguishable from a second portion of the thumbnail image that corresponds to a second amount of time of the content that follows the position.

12. The apparatus of claim 11, wherein the control unit modifies the first portion to be distinguishable from the second portion by modifying a color of the first portion of the thumbnail image to be a grayscale color.

13. The apparatus of claim 10, wherein the control unit determines a remaining power of a playback device that outputs the content and estimates a possible playback time of the content based on the remaining power and modifies the first portion of the that corresponds to a first amount of time of the content that precedes the possible playback time to be distinguishable from a second portion of the thumbnail image that corresponds to a second amount of time of the content that follows the possible playback time.

14. The apparatus of claim 13, wherein the control unit modifies the first portion to be distinguishable from the second portion by modifying a color of the second portion of the thumbnail image to be a grayscale color.

15. The apparatus of claim 10, wherein the control unit obtains information regarding an estimated playback time of the content, maps the entire thumbnail image to an overall playback time of the content, and modifies a first portion of the thumbnail image corresponding to a segment of the content which is estimated to be played back to be distinguishable from a second portion of the thumbnail image corresponding to a segment of the content which is estimated to not be played back.

16. The apparatus of claim 10, wherein the control unit changes a color of a portion of the thumbnail image, based on the additional information.

17. The apparatus of claim 10, wherein the control unit obtains a second thumbnail image and second additional information related to second content, modifies the second thumbnail image based on the second additional information, and displays the modifies thumbnail image and the modified second thumbnail image as a list via the display.
